(19) United States
(12) Patent Application Publication
(10) Pub. No.: US 2009/0163644 A1
(43) Pub. Date: Jun. 25, 2009

(54) SLOW-CURING, QUICK-DRYING AQUEOUS PAINT USABLE IN COMBINATION WITH OIL-BASED PAINT

(76) Inventors: Kouichi Nomura, Saitama (JP); Kenichi Matsumoto, Tokyo (JP)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/095,296

(22) PCT Filed: Apr. 23, 2007
(86) PCT No.: PCT/JP2007/058711

§ 371 Date: May 28, 2008

(30) Foreign Application Priority Data
May 11, 2006 (JP) 2006-132373

(51) Int. Cl. C08L 67/06

(52) U.S. Cl. 524/556

(57) ABSTRACT

A paint which can be used in combination with either an aqueous paint or an oil-based paint, and which has a quick-drying property and a slow-curing property may comprise a water-dispersible acryl-modified alkyd resin as an active ingredient. The paint may comprise a water-dispersible acryl-modified alkyd resin and a water-dispersible polymer as active ingredients. The paint may comprise a water-dispersible acryl-modified alkyd resin and a surfactant as active ingredients. The paint may comprise a water-dispersible acryl-modified alkyd resin, a pigment, an extender pigment, a surfactant and water as active ingredients.

### TECHNICAL FIELD

The present invention relates to an aqueous paint which can be used in combination with an oil-based paint and has a specific curing property.

Conventional paints can be classified into oil-based alkyd paints, acrylic paints and tempera paints, depending on the binder used. None of them are, however, suitable for being used in combination with an aqueous paint or an oil-based paint.

In such circumstances, a paint containing a water dispersible alkyd resin as a chief ingredient is discussed (in, for example, Japanese Patent Application Laid-Open No. 2002-192899) as a paint which can be used in combination with an aqueous paint or an oil-based paint.

The water-dispersible alkyd resins of the prior art include many kinds of alkyd resins, such as fatty acid modified alkyd resins, urethane modified alkyd resins, epoxy-modified alkyd resins and oil-free polyester resins. However, many of them are of forced-dry type or of bake-dry type and as such, have the problem of being unsuitable for use in paints.

In addition, from the viewpoint of processing/washing of paintings, paints are desirable which are slow to be cured after being dried, because processing/washing of paintings become very difficult if paints are cured immediately after being dried.

Accordingly, the object of the present invention is to provide a paint which can be used in combination with an aqueous paint or an oil-based paint and has a quick-drying property and a slow-curing property.

### DISCLOSURE OF THE INVENTION

After directing tremendous research efforts toward solving the above problem, the present inventors found that an aqueous paint in which a water-dispersible acryl-modified alkyd resin is used is usable in combination with an oil-based paint and is slow to be cured after being dried. And finally they have made the present invention.

To achieve the above object, the aqueous paint of the present invention, which is usable in combination with an oil-based paint and has a slow-curing property and a quick drying property, is made to contain a water-dispersible acryl-modified alkyd resin as an active ingredient. Further, the paint of the present invention is made to contain a water-dispersible acryl-modified alkyd resin and a water-dispersible polymer as active ingredients. Further, the paint of the present invention is made to contain a water-dispersible acryl-modified alkyd resin and a surfactant as active ingredients. Still further, the paint of the present invention is made to contain a water-dispersible acryl-modified alkyd resin, a pigment, an extender pigment, a surfactant and water as active ingredients.

A water-dispersible acryl-modified alkyd resin is used as a binder in the paint. And a water-dispersible polymer, such as an acrylic resin or urethane resin, can also be added to the paint.

A surfactant can be added to combine water and oil at water/oil interface, thereby reducing the surface tension of the paint.

A pigment acts as a coloring ingredient. Examples of pigments include various types of organic pigments and inorganic pigments.

An extender pigment can be used to help the coloring and reduce the cost. Examples of extender pigments include barium sulfate, calcium carbonate and clay.

Water is used as a solvent for adjusting the concentration and fluidity of the paint.

A wetting dispersant for pigment dispersion can be used as an additive.

A various kinds of paint defoamer can be added to control or remove foam at the time of paint production or painting.

A various kinds of organic or inorganic fluidity modifiers can be added so as to improve the fluidity of the paint or prevent the pigment from settling.

A various kinds of paint surface modifiers can be added to eliminate defects on paint surface.

A various kinds of preservatives or mildewproofing agents can be added to obtain the shelf stability of the paint.

The paint of the present invention can be produced using the same dispersion technique as is used in the conventional paint production method. Specifically, the dispersion is mixing dispersion using a mixer, or dispersion using a triple roll mill, or pearl mill.

The aqueous paint of the present invention is as described so far, and therefore, the aqueous paint is easy to handle in its processing/cleaning operation, unlike conventional quick-drying paints, it is usable in combination with an oil-based paint, and it has shelf stability.

### EXAMPLES

In the following the present invention will be described by examples and comparative examples. A pigment representative of each of the following pigment classes is selected and used as the color of each sample.

Titanium oxide, as a representative of inorganic oxide-based white pigments, cobalt blue, as a representative of mixed-metal-oxide-based inorganic pigments, red iron oxide, as a representative of inorganic oxide pigments, and phthalocyanine blue, as a representative of organic pigments, are used.

### Example 1

### Titanium Oxide

Water-dispersible acryl-modified alkyd resin 40.0 Fatty acid ester defoamer 0.7 Acrylic copolymer wetting dispersant 1.7 Titanium oxide 32.4 Silica-based flatting agent 0.9 Sorbitan fatty acid ester and ethylene oxide adduct 4.0 Sodium montmolillonite 2.0 Water 18.0 Modified polysiloxane 0.2 Benzoisothiazoline 0.01.

### Example 2

### Cobalt Blue

Water-dispersible acryl-modified alkyd resin 50.0 Fatty acid ester defoamer 1.0 Acrylic copolymer wetting dispersant 0.8 Cobalt blue 16.1 Silica-based flatting agent 0.9 Sorbitan fatty acid ester and ethylene oxide adduct 5.0 Sodium montmolillonite 2.3 Water 23.4 Modified polysiloxane 0.3 Benzoisothiazoline 0.02.

### Example 3

### Red Iron Oxide

Water-dispersible acryl-modified alkyd resin 46.4 Fatty acid ester defoamer 0.8 Red iron oxide (easily dispersible product) 23.2 Silica-based flatting agent 1.5 Sorbitan fatty acid ester and ethylene oxide adduct 4.6 Sodium montmolillonite 2.3 Water 20.9 Modified polysiloxane 0.2 Benzoisothiazoline 0.01.

### Example 4

### Phthalocyanine Blue

Water-dispersible acryl-modified alkyd resin 56.5 Fatty acid ester defoamer 0.9 β-Form phthalocyanine blue (easily dispersible product) 6.6 Silica-based flatting agent 1.8 Sorbitan fatty acid ester and ethylene oxide adduct 5.6 Sodium montmolillonite 2.8 Water 25.4 Modified polysiloxane 0.2 Benzoisothiazoline 0.02.

### Comparative Example A1

### Acrylic Paint, Titanium Oxide

Water-dispersible acrylic resin 44.00 Propylene glycol 2.0 Hydrophobic polymer defoamer 0.3 Polycarboxylic acid-type wetting dispersant 0.3 Titanium oxide 33.0 Silica-based flatting agent 0.9 Sodium montmolillonite 1.9 Water 17.1 Modified polysiloxane 0.3 Benzoisothiazoline 0.02.

### Comparative Example A2

### Acrylic Paint, Cobalt Blue

Water-dispersible acrylic resin 48.0 Propylene glycol 5.0 Hydrophobic polymer defoamer 0.5 Polycarboxylic acid-type wetting dispersant 0.2 Cobalt blue 15.0 Silica-based flatting agent 0.9 Sodium montmolillonite 2.5 Water 25.7 Modified polysiloxane 0.2 Benzoisothiazoline 0.02 Association thickener 1.8.

### Comparative Example A3

### Acrylic Paint, Red Iron Oxide

Water-dispersible acrylic resin 46.0 Propylene glycol 4.5 Hydrophobic polymer defoamer 0.5 Acrylic copolymer wetting dispersant 3.6 Red iron oxide 23.0 Silica-based flatting agent 0.9 Sodium montmolillonite 2.1 Water 18.9 Modified polysiloxane 0.3 Benzoisothiazoline 0.02.

### Comparative Example A4

### Acrylic Paint, Phthalocyanine Blue

Water-dispersible acrylic resin 50.0 Propylene glycol 4.0 Hydrophobic polymer defoamer 0.6 β-Form phthalocyanine blue (liquid dispersion) 10.0 Silica-based flatting agent 1.1 Sodium montmolillonite 3.4 Water 30.5 Modified polysiloxane 0.2 Benzoisothiazoline 0.02.

### Comparative Example B1

### Watercolor Paint, Titanium Oxide

Gum arabic 19.0 Water 27.8 Ethylene glycol 8.5 Glycerin 0.7 Benzoisothiazoline 0.05 Hydrophobic polymer defoamer 0.2 Polycarboxylic acid-type wetting dispersant 1.1 Titanium oxide 38.8 Calcium carbonate 1.2 Polyacrylic thickener 1.8 pH Adjuster 0.4.

### Comparative Example B2

### Watercolor Paint, Cobalt Blue

Gum arabic 23.4 Water 25.8 Ethylene glycol 7.6 Glycerin 2.5 Benzoisothiazoline 0.06 Hydrophobic polymer defoamer 0.2 Cobalt blue 38.0 Barium sulfate 1.9.

### Comparative Example B3

### Watercolor Paint, Red Iron Oxide

Gum arabic 14.0 Water 22.6 Ethylene glycol 4.5 Glycerin 1.5 Benzoisothiazoline 0.04 Hydrophobic polymer defoamer 0.1 Acrylic copolymer wetting dispersant 2.7 Red iron oxide 37.3 Calcium carbonate 15.6 Sodium montmolillonite 1.3.

### Comparative Example B4

### Watercolor Paint, Phthalocyanine Blue

Gum arabic 26.5 Water 36.3 Ethylene glycol 8.6 Glycerin 2.9 Benzoisothiazoline 0.07 Hydrophobic polymer defoamer 0.3 Acrylic copolymer wetting dispersant 1.0 β-Form phthalocyanine blue 8.7 Calcium carbonate 14.7 Sodium montmolillonite 1.0.

### Comparative Example C1

### Epoxy-Modified Alkyd Paint, Titanium Oxide

Water-dispersible epoxy-modified alkyd resin 29.7 Triethylamine 1.2 Water 23.7 Modified silicon 0.1 Titanium oxide 44.4 Urethane modified polyether 0.7 Modified polysiloxane 0.2.

### Comparative Example C2

### Epoxy-Modified Alkyd Paint, Cobalt Blue

Water-dispersible epoxy-modified alkyd resin 40.4 Triethylamine 1.7 Water 32.4 Modified silicon 0.1 Cobalt blue 24.2 Urethane modified polyether 0.9 Modified polysiloxane 0.3.

### Comparative Example C3

### Epoxy-Modified Alkyd Paint, Red Iron Oxide

Water-dispersible epoxy-modified alkyd resin 36.2 Triethylamine 1.5 Water 28.9 Modified silicon 0.1 Red iron oxide (easily dispersible product) 32.5 Urethane modified polyether 0.7 Modified polysiloxane 0.3

### Comparative Example C4

### Epoxy-Modified Alkyd Paint, Phthalocyanine Blue

Water-dispersible epoxy-modified alkyd resin 48.6 Triethylamine 2.0 Water 38.8 Modified silicon 0.1 β-Form phthalocyanine blue 9.1 Urethane modified polyether 1.0 Modified polysiloxane 0.4.

The formulation ingredients of each of the above examples and comparative examples were mixed using a laboratory mixer for 15 minutes and dispersed once using a triple roll mill to obtain an aqueous pigment composition. Each of the aqueous pigment compositions obtained in examples and comparative examples met the requirements for a paint.

### Comparative Example 1

The paints of Examples 1 to 4 and Comparative Examples A1 to C4 were applied onto:

1. a canvas (acryl, used both for an aqueous paint and an oil-based paint);
2. a dried film of an oil-based paint; and
3. an undried film of an oil-based paint and the wettability by the paints to the surface onto which the paints were applied was compared. The results are shown in Table 1.

TABLE 1

| Condition | Sample | Binder | 1 | 2 | 3 | 4 |
|---|---|---|---|---|---|---|
| On | Examples | water-dispersible acryl- | good | good | good | good |
| canvas | | modified alkyd resin | | | | |
| | Comparative | water-dispersible acryl | good | good | good | good |
| | Examples A | resin | | | | |
| | Comparative | gum Arabic | fair | poor | fair | fair |
| | Examples B | | | | | |
| | Comparative | water-dispersible epoxy- | good | good | good | good |
| | Examples C | modified alkyd resin | | | | |
| On dried | Examples | water-dispersible acryl- | fair | fair | fair | fair |
| oil-based | | modified alkyd resin | | | | |
| paint | Comparative | water-dispersible acryl | fair | fair | fair | fair |
| | Examples A | resin | | | | |
| | Comparative | gum Arabic | poor | poor | poor | poor |
| | Examples B | | | | | |
| | Comparative | water-dispersible epoxy- | fair | fair | fair | fair |
| | Examples C | modified alkyd resin | | | | |
| On | Examples | water-dispersible acryl- | fair | fair | fair | fair |
| undried | | modified alkyd resin | | | | |
| oil-based | Comparative | water-dispersible acryl | poor | poor | poor | poor |
| paint | Examples A | resin | | | | |
| | Comparative | gum Arabic | poor | poor | poor | poor |
| | Examples B | | | | | |
| | Comparative | water-dispersible epoxy- | fair | fair | fair | fair |
| | Examples C | modified alkyd resin | | | | |

(“Examples” means Examples 1 to 3, “Comparative Examples A” means Comparative Examples A1 to A4, “Comparative Examples B” means Comparative Examples B1 to B4, and “Comparative Examples C” means Comparative Examples C1 to C4.)

The paints of Examples 1 to 4 and Comparative Examples A1 to C4 were applied onto:

1. a canvas (acryl, used both for an aqueous paint and an oil-based paint);
2. a dried film of an oil-based paint; and
3. an undried film of an oil-based paint and dried at ordinary temperature for 40 days.
Then cross cut test was carried out in accordance with JIS K5400: 6.15 to examine the layer-to-layer adhesion. The results are shown in Table 2 below.

TABLE 2

| Condition | Sample | Binder | 1 | 2 | 3 | 4 |
|---|---|---|---|---|---|---|
| On | Examples | water-dispersible acryl- | good | good | good | good |
| canvas | | modified alkyd resin | | | | |
| | Comparative | water-dispersible acryl | good | good | good | good |
| | Examples A | resin | | | | |
| | Comparative | gum Arabic | poor | untestable | poor | poor |
| | Examples B | | | | | |
| | Comparative | water-dispersible epoxy- | good | good | good | good |
| | Examples C | modified alkyd resin | | | | |
| On dried | Examples | water-dispersible acryl- | good | good | good | good |
| oil-based | | modified alkyd resin | | | | |
| paint | Comparative | water-dispersible acryl | poor | poor | poor | poor |
| | Examples A | resin | | | | |
| | Comparative | gum Arabic | untestable | untestable | untestable | untestable |
| | Examples B | | | | | |
| | Comparative | water-dispersible epoxy- | good | good | good | good |
| | Examples C | modified alkyd resin | | | | |
| On | Examples | water-dispersible acryl- | good | good | good | good |
| undried | | modified alkyd resin | | | | |
| oil-based | Comparative | water-dispersible acryl | poor | poor | poor | poor |
| paint | Examples A | resin | | | | |
| | Comparative | gum Arabic | untestable | untestable | untestable | untestable |
| | Examples B | | | | | |
| | Comparative | water-dispersible epoxy- | good | good | good | good |
| | Examples C | modified alkyd resin | | | | |

(“Examples” means Examples 1 to 3, “Comparative Examples A” means Comparative Examples A1 to A4, “Comparative Examples B” means Comparative Examples B1 to B4, “Comparative Examples C” means Comparative Examples C1 to C4, and “untestable” means that the test could not be carried out because the paint could not be applied.)

### Comparative Example 3

The paints of Examples 1 to 4 and Comparative Examples A1 to C4 were applied onto water proof paper 50 μm thick to prepare samples. The ball of a finger was pressed on the surface of each sample at a pressure of 200 gram/cm², at room temperature and the time required for the paint not to adhere to the ball of finger was measured as tack time. The results are shown in Table 3 below.

TABLE 3

| Test | | | | | | |
|---|---|---|---|---|---|---|
| item | Sample | Binder | 1 | 2 | 3 | 4 |
| | Examples | water-dispersible acryl- | 17 | 16 | 19 | 25 |
| | | modified alkyd resin | | | | |
| Tack | Comparative | water-dispersible acryl | 14 | 12 | 20 | 18 |
| time | Examples A | resin | | | | |
| | Comparative | gum Arabic | 18 | 22 | 16 | 14 |
| | Examples B | | | | | |
| | Comparative | water-dispersible epoxy- | 320 | 290 | 330 | 350 |
| | Examples C | modified alkyd resin | | | | |

Unit: minutes (average value from five measurements) (“Examples” means Examples 1 to 3, “Comparative Examples A” means Comparative Examples A1 to A4, “Comparative Examples B” means Comparative Examples B1 to B4, and “Comparative Examples C” means Comparative Examples C1 to C4.)

### Comparative Example 4

The paints of Examples 1 to 4 and Comparative Examples A1 to B4 were applied onto water proof paper 50 μm thick to prepare samples. The samples were dried at room temperature. Thirty minutes, 24 hours and 4 weeks after the drying, the surface of each of the dried samples was rubbed back and forth, at a pressure of 400 gram/cm², five times with a water moistened nylon brush and whether the paint was dissolved in water or not was observed. The results are shown in Table 4 below.

TABLE 4

| Time | | | | | | |
|---|---|---|---|---|---|---|
| elapsed | Sample | Binder | 1 | 2 | 3 | 4 |
| 30 min. | Examples | water-dispersible acryl- | Dissolved | Dissolved | Dissolved | Dissolved |
| | | modified alkyd resin | | | | |
| | Comparative | water-dispersible acryl | Not | Not | Not | Not |
| | Examples A | resin | dissolved | dissolved | dissolved | dissolved |
| | Comparative | gum Arabic | Dissolved | Dissolved | Dissolved | Dissolved |
| | Examples B | | | | | |
| | Comparative | water-dispersible epoxy- | Dissolved | Dissolved | Dissolved | Dissolved |
| | Examples C | modified alkyd resin | | | | |
| 24 hrs. | Examples | water-dispersible acryl- | Dissolved | Dissolved | Dissolved | Dissolved |
| | | modified alkyd resin | | | | |
| | Comparative | water-dispersible acryl | Not | Not | Not | Not |
| | Examples A | resin | dissolved | dissolved | dissolved | dissolved |
| | Comparative | gum Arabic | Dissolved | Dissolved | Dissolved | Dissolved |
| | Examples B | | | | | |
| | Comparative | water-dispersible epoxy- | Not | Not | Not | Not |
| | Examples C | modified alkyd resin | dissolved | dissolved | dissolved | dissolved |
| 4 weeks | Examples | water-dispersible acryl- | Not | Not | Not | Not |
| | | modified alkyd resin | dissolved | dissolved | dissolved | dissolved |
| | Comparative | water-dispersible acryl | Not | Not | Not | Not |
| | Examples A | resin | dissolved | dissolved | dissolved | dissolved |
| | Comparative | gum Arabic | Dissolved | Dissolved | Dissolved | Dissolved |
| | Examples B | | | | | |
| | Comparative | water-dispersible epoxy- | Not | Not | Not | Not |
| | Examples C | modified alkyd resin | dissolved | dissolved | dissolved | dissolved |

(“Examples” means Examples 1 to 3, “Comparative Examples A” means Comparative Examples A1 to A4, “Comparative Examples B” means Comparative Examples B1 to B4, and “Comparative Examples C” means Comparative Examples C1 to C4.)

The results of Comparative Examples 1 and 2 prove that the paint of the present invention can be appropriately used in combination with an aqueous paint and an oil-based paint. Further, the results of Comparative Examples 3 and 4 prove that the paint of the present invention is characterized by having not only a quick-drying property but a slow-curing property.

1. A slow-curing, quick-drying aqueous paint which can be used in combination with an oil-based paint, characterized by comprising a water-dispersible acryl-modified alkyd resin as an active ingredient.

2. A slow-curing, quick-drying aqueous paint which can be used in combination with an oil-based paint, characterized by comprising a water-dispersible acryl-modified alkyd resin and a water-dispersible polymer as active ingredients.

3. A slow-curing, quick-drying aqueous paint which can be used in combination with an oil-based paint, characterized by comprising a water-dispersible acryl-modified alkyd resin and a surfactant as active ingredients.

4. A slow-curing, quick-drying aqueous paint which can be used in combination with an oil-based paint, characterized by comprising a water-dispersible acryl-modified alkyd resin, a pigment, an extender pigment, surfactant, and water as active ingredients.
